(19) United States
(12) Patent Application Publication
(10) Pub. No.: US 2018/0167585 A1
(43) Pub. Date: Jun. 14, 2018

(54) Networked Camera

(71) Applicants: Richard Ang Ang, Medina, WA (US); Richmond Ang, Medina, WA (US)

(72) Inventors: Richard Ang Ang, Medina, WA (US); Richmond Ang, Medina, WA (US)

(21) Appl. No.: 15/374,853

(22) Filed: Dec. 9, 2016

(51) Int. Cl. H04N 7/18; H04L 12/58; H04L 29/08; G08B 25/00; H04N 5/232; G06K 9/00

(52) U.S. Cl. CPC H04N 7/181; H04L 51/046; H04L 51/08; H04W 84/18; G08B 25/006; H04N 5/23206; G06K 9/00288; H04L 67/10

(57) ABSTRACT

Several networked cameras may communicate with and control each other to increase the security of a location. If one camera detects a person entering the premises, it may send a notification to one or more other cameras to tilt and pan to observe the person as well. The networked cameras may be able to transmit real-time images and live high-definition (HD) video, as well as email, text, or audio notifications to users regarding the status entry. Other devices, such as motion sensors, photoelectric beam detectors, thermal detectors, sirens, door openers, alarm panels or hubs may also be integrated with the network.

### FIELD

This disclosure relates generally to a networked camera.

### BACKGROUND

Installing cameras around a property may help with monitoring a surrounding area. Conventional camera systems may use passive monitoring where videos are recorded to a central device and videos are viewed after the event has occurred. Also, a camera system may use motion detection method and set off an alert signal if motion is detected.

### SUMMARY

The following presents a simplified summary of the disclosure to provide a basic understanding to the reader. This summary is not an extensive overview of the disclosure, nor does it identify key or critical elements of the claimed subject matter, or define its scope. Its sole purpose is to present some concepts disclosed in a simplified form as a precursor to the more detailed description that is later presented.

The instant application discloses, among other things, a networked camera, which may be a node on a mesh network, a distributed network, a star-topology network, or other type of network. A networked camera may generate and transmit data to other networked cameras. For example, it may be connected directly to other networked cameras and devices on a network, and may communicate and exchange data with other networked cameras, alarm panels, hubs and devices on that network.

In one embodiment a networked camera may be networked with cameras or connected to internet of things (IoT) devices and sensors, such as a beam detector, switches, sensors or other appliances. If the beam detector or sensor is triggered, it may send data to the networked camera. The networked camera may issue a command or a message, for example, an unconditional or a conditional command, to other networked cameras, alarm panels, hubs or devices such as a safety alarm device, a panic alarm device, a sprinkler system, or a wireless siren strobe alarm. If a message is triggered, a networked camera may issue a command to another networked camera or set of networked cameras, and conduct coordinated control or monitoring. For example, a first networked camera with a beam, metal, thermal or other type of detector may send alerts to a user and may send a command to a second and third networked camera commanding them to sweepingly survey a geographical area or scan a particular set of coordinates, activate the siren on an alarm panel for 3^{rd} party monitoring, or activate other devices, such as opening and closing of door and gates, activate lights or sirens and other controlling events.

In another embodiment, a networked camera may be configured to communicate through IoT hubs on a network. IoT hubs may re-direct communications to other networked cameras or devices, like a safety detector device, a smoke detector device, a photoelectric beam detector, a sound wave detector, or a metal detector.

In yet another embodiment, a networked camera may send a notification message to landline and cellular phones, or send email messages to one or more addresses. For example, a networked camera may send a notification message to police, fire department, or another emergency service agency, via phone, text message, or email. A network camera may directly communicate with an alarm panel and may act as a coordinating point for other networked cameras for coordinated action when a breach occurs. A networked camera may collect and handle image data, including pictures or videos, for example. For example, it may take a photograph or capture a video clip and subsequently store those photographs or video contents to a file or otherwise share access to those data, which may be stored on a server or local storage, for example. A networked camera may transmit a message containing data like a photograph or video clip via email, for example, or by sharing access to stored photograph or video contents via a link to uploaded content or by transmitting content directly in an email message.

In another embodiment, a networked camera may be configured to analyze captured image data to conduct facial recognition, car license plate recognition, thermal recognition, or object recognition. For example, a networked camera may receive a conditional instruction to instruct a device to unlock a door only if a person authorized to enter an area is identified via facial recognition. Conversely, if a person is identified as a threat, a networked camera may activate a siren, send a message to the alarm panel, or send an alert to an appropriate authority. A message or alert may include visual verification of the threat, including visual proof, for example a picture or video.

Many of the attendant features may be more readily appreciated as they become better understood by reference to the following detailed description considered in connection with the attached drawings.

### BRIEF DESCRIPTION OF THE DRAWINGS

FIG. 1 illustrates a set of networked cameras on a network, according to one embodiment.

FIG. 2 is a front perspective view of Networked Camera 200, according to one embodiment.

FIG. 3 illustrates a rear view of a networked camera, according to one embodiment.

FIG. 4 is a flow diagram illustrating an example of one implementation of networked cameras according to one embodiment.

FIG. 5 illustrates a location identifying technique, according to one embodiment.

FIG. 6 is a block diagram illustrating tracking an object detected by a device that communicates with a networked camera, according to one embodiment.

FIG. 7 is a diagram illustrating an example of a system capable of supporting networked cameras according to one embodiment.

FIG. 8 is a flow diagram illustrating a process for a networked camera according to one embodiment.

FIG. 9 is a component diagram of a computing device which may support a network camera according to one embodiment.

### DETAILED DESCRIPTION

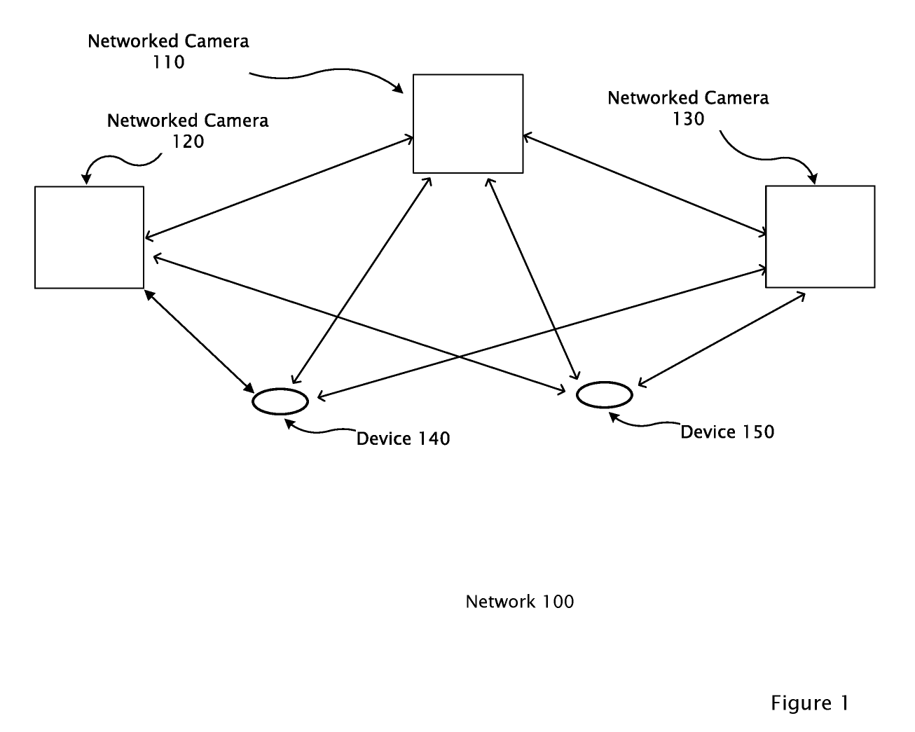

FIG. 1 is a block diagram illustrating Network 100 that includes a set of Networked Cameras 110, 120, 130 according to one embodiment. Multiple instances of Networked Cameras 110, 120, 130 may be combined as nodes to create Network 100, which may be a mesh network, or may use other network topologies. As nodes, Networked Cameras 110, 120, 130 may have a network path identification and a node identification that may be initialized, modified or deleted. For example, the number of networked cameras on a network may increase or decrease without interrupting a flow of messages along a network path.

In one embodiment of Network 100, these nodes may be connected to Device 140, 150, which may be, for example, a motion sensor, a photoelectric beam detector, an internet of things (IoT) device, a safety alarm device, a panic alarm device, a sprinkler system control device, an alarm panel or a wireless siren strobe alarm device. Device 140, 150 may or may not be capable of bidirectional communication. Network 100 may include multiple instances of Device 140. Networked Cameras 110, 120, 130 nodes may be capable of bidirectional communication, for instance, they may be equipped with the capability to communicate and exchange data with other nodes and Devices 140 so that Network 100 may not include a hub. In another embodiment, a node in Network 100 may be configured to operate with capabilities that resemble those of a hub.

Networked Cameras 110, 120, 130 nodes in Network 100 may generate and transmit data, such as image data as in video data or photograph data, or communication data as in messages or control commands. These nodes may be configured to both output unconditional or conditional commands and process inputs from other Devices 140 or nodes.

In one embodiment, Networked Cameras 110, 120, 130 may be connected directly to each other and all other Devices 140, 150 in Network 100 via peer-to-peer networking. Various algorithms may be used to categorize events for Networked Camera 110, 120, 130. Event categories for each node may vary depending on a user's purpose for surveillance. Simultaneous camera recording may help fully capture various event categories, such as perimeter breached events associated with crossing a perimeter or motion events associated with multiple moving objects. Networked cameras may coordinate its movement, so a camera will automatically move to a location triggered by the breach, or the networked cameras may communicate to another camera located in a different location and coordinate controlling events.

As an illustration of handling an event, if Device 140, a photoelectric beam detector, for example, is triggered, it may send data to Networked Camera 110. Networked Camera 110 may issue an unconditional or a conditional command to Device 150, which may be, for example, a safety alarm device, a panic alarm device, a sprinkler system, or a wireless siren strobe alarm.

In other implementations of handling the scenario described above, Networked Camera 110 may send a command to Networked Cameras 120 or 130 in order to conduct coordinated monitoring. For example, Networked Cameras 120 and 130 may simultaneously receive a command to record a video segment while monitoring a geographical area and activate Device 150, for example.

In yet another embodiment, Networked Camera 110 may send a notification message to landline and cellular phones, and send email messages to one or more addresses. For example, Networked Camera 110 may send a notification message to the police, fire department, or another emergency service agency, via phone, text message, or email.

In another embodiment, Networked Cameras 110, 120, 130 may be configured to communicate through IoT hubs on a network. IoT hubs may re-direct communications to these nodes or Devices 140, 150.

In some embodiments of Network 100, Networked Cameras 110, 120, 130 nodes may relay data for Network 100, such that all Network's 100 network paths allow for continuous connections. In the event that Networked Camera 120 breaks down, another Networked Camera 130 may reconfigure messages around broken Networked Camera 120 on Network 100.

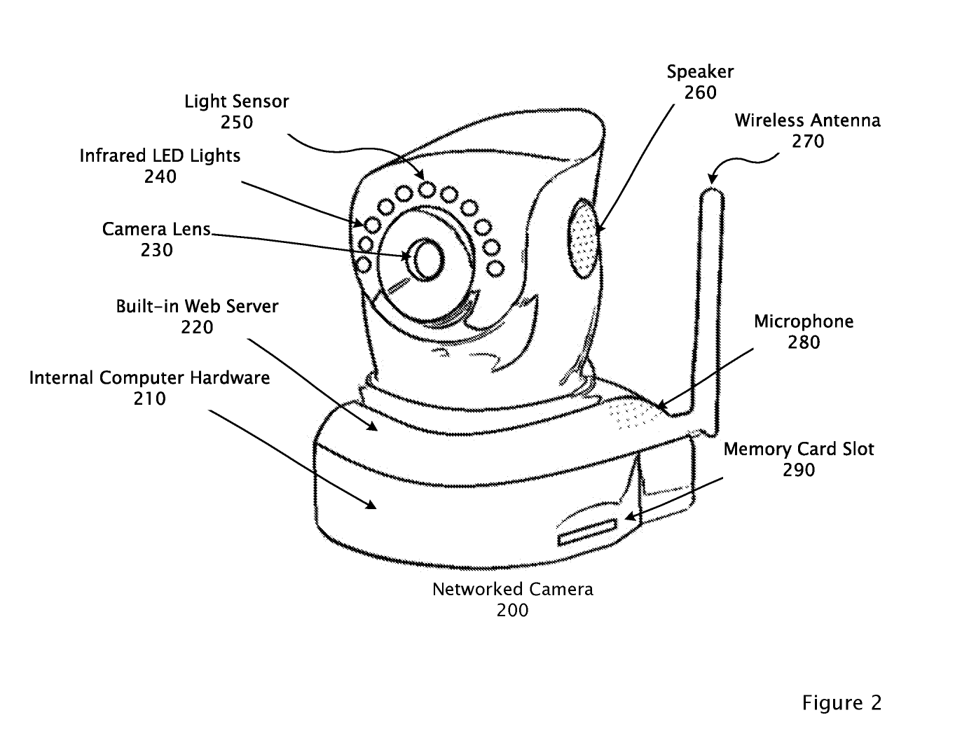

FIG. 2 is a front perspective view of Networked Camera 200, according to one embodiment. Here, Networked Camera 200 may comprise an internet protocol (IP) camera with Internal Computer Hardware 210 built into the camera housing. Software written specifically for Networked Camera 200 may run on the Internal Computer Hardware 210. The software may enable Networked Camera 200 to function as a controlling unit for any single or plurality of objects, such as other cameras, garage doors, light switches, power sockets, fire detectors, carbon monoxide detectors, appliances, sirens, strobe lights, and motor vehicles, for instance.

Software running on Internal Computer Hardware 210 may interact directly with Built-in Web Server 220. Built-in Web Server 220 may be configured to send and receive data so as to allow a user to remotely monitor, control, and receive notifications about an object. Built-in Web Server 220 may also be used to authenticate the users using various methods such as Digest or Basic Authentication and utilizing http or https. A user may send and receive the information through any device, such as a computer or a smartphone, for example. Networked Camera 200 may connect to the Internet and other devices using wired networking or any wireless means such as Wi-Fi, using its Wireless Antenna 270. Networked Camera 200 may also be equipped with Bluetooth, near-field communication (NFC), Zigbee, Z-wave, various Radio Frequencies or other wireless capabilities.

Networked Camera 200 may include a Camera Lens 230 with any range of zoom capabilities and may be capable of capturing and transmitting high-definition (HD) still and video images in various resolution settings. Networked Camera 200 may also have full pan-tilt control, allowing it to engage in vertical, horizontal, upward, and downward movements, for example. Infrared LED Lights 240 and Light Sensor 250 may provide night vision capability, enabling Networked Camera 200 to function in low-light or pitch black environments. Speakers 260 and Microphone 280 may allow for bidirectional communication through Networked Camera 200. Networked Camera 200 may store data directly into the camera unit or on any other memory device, for instance, a secure digital (SD) card, which may be inserted into Memory Card Slot 290.

In some embodiments, Networked Camera 200 may collect and handle image data, as it may take a photograph or capture a video clip and subsequently store those photograph or video contents to a file or a server or otherwise share access to those data contents, which may be stored on a remote server or transmitted via an email message. Networked Camera 200 may transmit a message containing data like a photograph or video clip via an email message, for example, by sharing access to stored photograph or video contents via a link to uploaded contents or by transmitting a copy of contents through an email message.

In another embodiment, Networked Camera 200 may be configured to analyze and process captured image data to conduct facial detection, car plate license recognition or object recognition. Accurately detecting people that cross a perimeter may reduce false alarms. For example, when a facial detection identification is positive, Networked Camera 200 may send a command to a Device 140 which may control a door lock and either deactivate door lock or trigger other devices such as alarms or trigger a terrorist alert notification depending on the result of face identification process.

In another embodiment, Networked Camera 200 may be configured to analyze and process captured image data to conduct person or object detection and recognition. Accurately detecting people that cross a perimeter or fall that may require emergency assistance, for example, may reduce delay in contacting emergency service agency, such as an ambulance or fire department. As an example, when a person fell down detection is positive, Networked Camera 200 may send a command to a Device 140 which may trigger an alert to emergency services depending on the result of person recognition and object detection process.

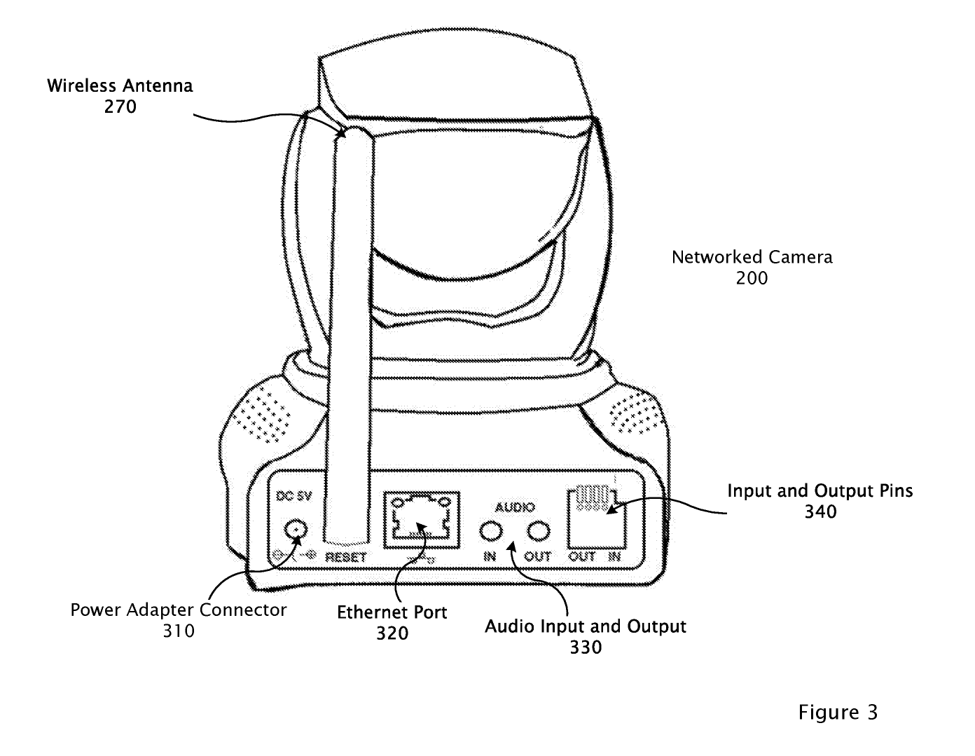

FIG. 3 is a rear view of Networked Camera 200, according to one embodiment. The rear side of Networked Camera 200 may include Power Adapter Connector 310, Wireless Antenna 270, Ethernet Port 320, Audio In and Out Ports 330, and Input and Output Pins 340 for a Device 140 connection.

One having skill in the art will recognize that multiple inputs and outputs may be used to control and monitor any number of devices.

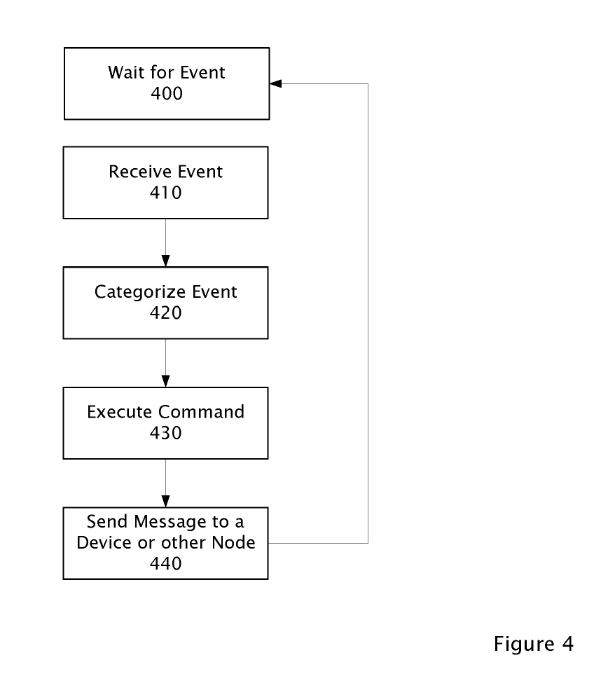

FIG. 4 is a flow diagram illustrating an example of one implementation for Networked Camera 110 according to one embodiment. Networked Camera 110 may Wait for Event 400. Networked Camera 110 may Receive Event 410 from Device 140. For example, a person may cross an invisible beam at the entrance of a building, triggering a photoelectric beam detector, or may have a gun which triggered a metal detector, which may signal Networked Camera 110 about the detected intrusion or prohibited item. Networked Camera 110 may Categorize Event 420. Various algorithms may be used to program Networked Camera 110 to categorize events. For example, Networked Camera 110 may execute a facial detection algorithm to determine the identity of a person who crossed the perimeter. The person may be identified as a threat, in which case a notification may be sent to one or more devices. Networked Camera 110 may Execute Command 430 if the identification is positive and Send Message to a Device or other Node 440. For example, Networked Camera 110 may open doors and inform other camera nodes that the person is not a threat. These other cameras may activate other devices. One having skill in the art will recognize that many types of verification may be used.

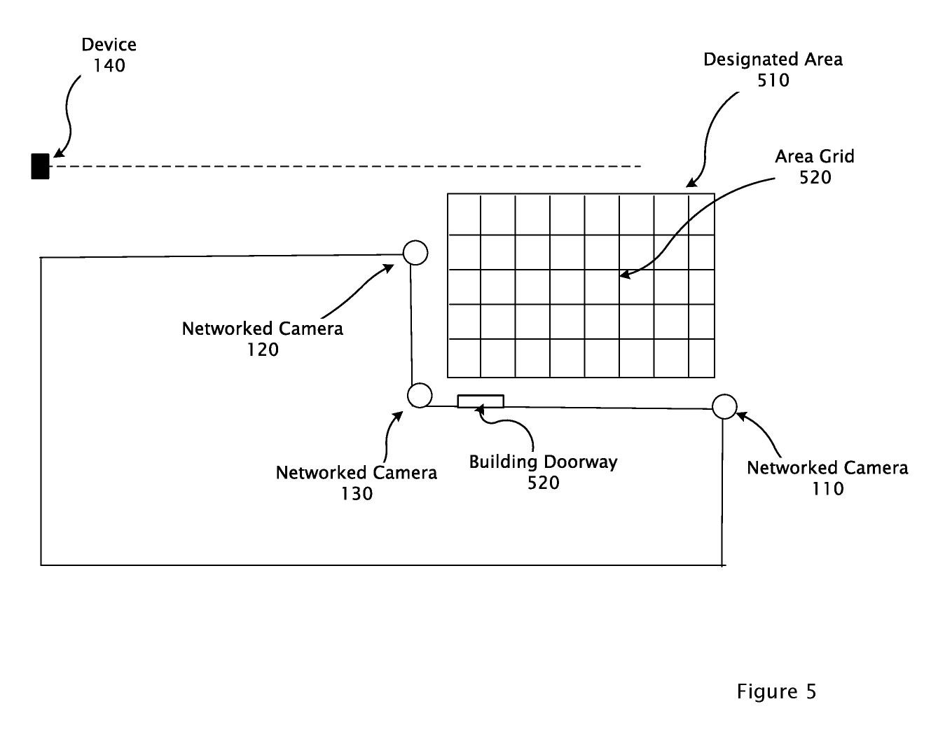

FIG. 5 illustrates a location identifying technique, according to one embodiment. For a Networked Camera 110, 120, 130, Area Grid 520 may be defined that maps and covers the Designated Area 510 observed by Networked Camera 110, 120, 130. This may allow Networked Camera 110 to coordinate Networked Cameras 120, 130 to attend to a particular location. In another embodiment, Designated Area 510 may be a general location, such as a patio, without using Area Grid 520.

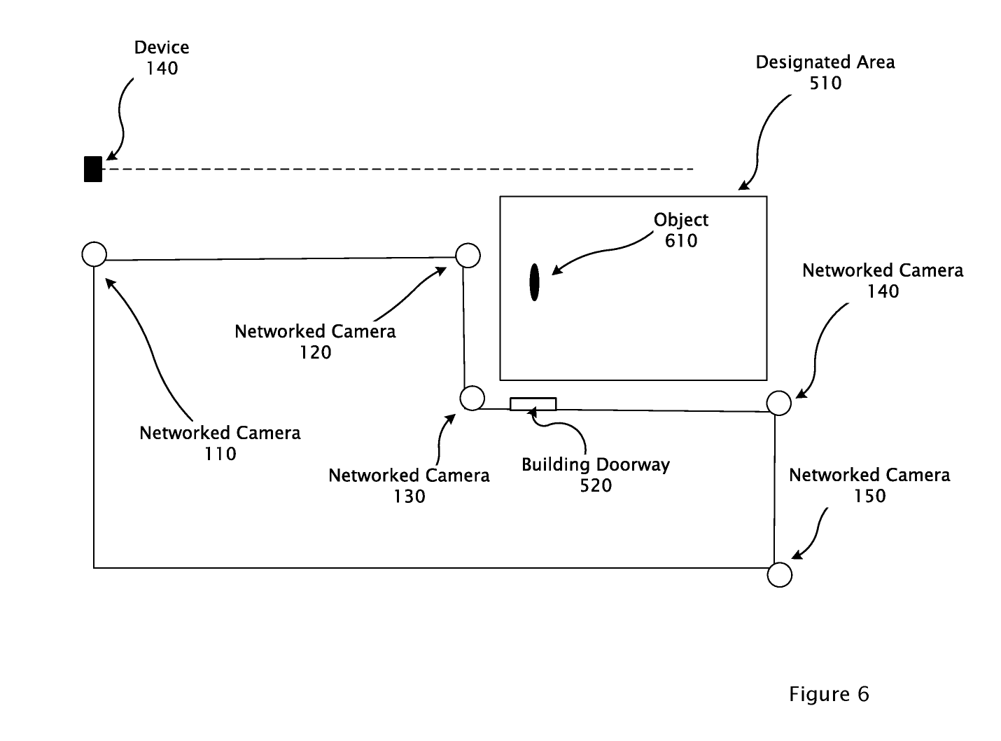

FIG. 6 is a block figure illustrating Device 140 sending a notification to Networked Camera 110. Networked Camera 110 may issue unconditional or conditional commands to other Device 150, such as a safety alarm device, panic alarm device, a sprinkler system, a boom gate, a security gate, alarm panel or a wireless siren strobe alarm.

A user may program Networked Cameras and define a map or association of Networked Cameras. Users may be able to control cameras, and program and establish relationships between Networked Cameras such that each camera in a local and remote network may be configured to communicate with other cameras and devices and simultaneously respond to particular events triggered within the network.

In one implementation of coordinated Networked Cameras, upon receiving a message that Object 610 was detected, Networked Camera 110 may send unconditional or conditional to Networked Cameras 120 and 130, and thus conduct coordinated monitoring of Object 610. Here, Networked Cameras 120 and 130 may simultaneously receive a command to pan to a location on Area Grid 520 and record a video segment where Object 610 was detected and activate Device 150, for example, an alarm.

Networked Camera 130 may distribute a notification message through landline and cellular phones, and send email messages to one or more addresses. As an example, Networked Camera 130 may send a notification message to the police or fire department, or other emergency service agency, via phone or email with an image of Object 610 attached to the message.

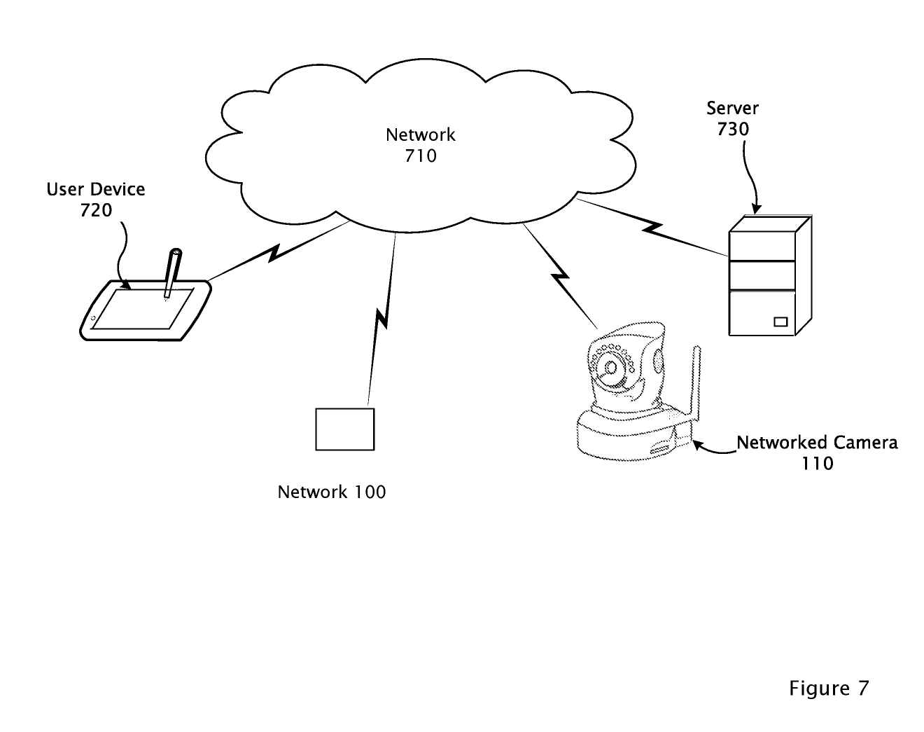

FIG. 7 is a diagram illustrating an example of a system capable of supporting Networked Camera according to one embodiment.

Network 710 may include Wi-Fi, cellular data access methods, such as 3G or 4GLTE, Bluetooth, near-field communications (NFC), various radio frequency signals, the internet, local area networks, wide area networks, or any combination of these or other means of providing data transfer capabilities. In one embodiment, Network 710 may comprise Ethernet connectivity. In another embodiment, Network 710 may comprise fiber optic connections.

User Device 720 may be a smartphone, tablet, laptop computer, or other device with location-based services, for example, GPS, cell phone tower triangulation capability, IP address location, or accelerometers, and may have network capabilities to communicate with Networked Camera 110.

Server 730 may be conventionally constructed or may be designed specifically to enhance communications and functionality of Networked Camera 110 and User Device 720.

Networked Camera 110 and Network 100 may establish a connection with Server 730 via Network 710. User Device 720 may also establish a connection with Server 730 via Network 710. User Device 720 may then communicate with Networked Camera 110, either directly through information received from Server 730, or by passing communications through Server 730, allowing commands and data to be transferred between User Device 720 and Networked Camera 110.

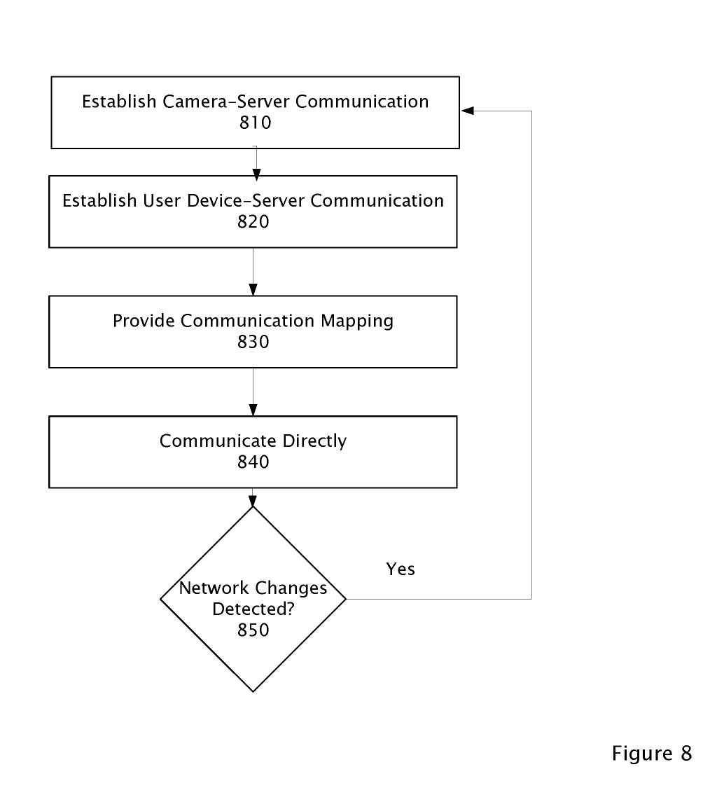

FIG. 8 is a flow diagram illustrating a process for Networked Camera according to one embodiment. A network may be configured to enable exchange of communications between Networked Cameras connected to the network. A network may include multiple networks or subnetworks. FIG. 5 shows an embodiment of a network that may carry out communication exchanges. Establish Camera-Server Communication 810 is where a connection may be established between Networked Camera located in a home associated with a user, for example, and Server 730.

At Establish User Device-Server Communication 820 is where one or more user devices may connect to Server 730 to enable communications with other devices and Networked Cameras connected to the network. A device may be configured to communicate over the network.

At Provided Communication Mapping 830 is where mapping of Networked Camera(s) identification information to information describing camera location and association to a user may be determined and stored. At this stage, mapping of device identification information to information describing device location or association to the user may also be determined and stored.

At Communicate Directly 840 an established connection between a set of Networked Cameras or a set of devices may be a direct connection so as to allow a device or Networked Camera or both to receive and send messages from other devices and other Networked Cameras.

At Network Changes Detected 850, if the network has been modified, a connection may be reestablished beginning at Establish Camera-Server Communication 810.

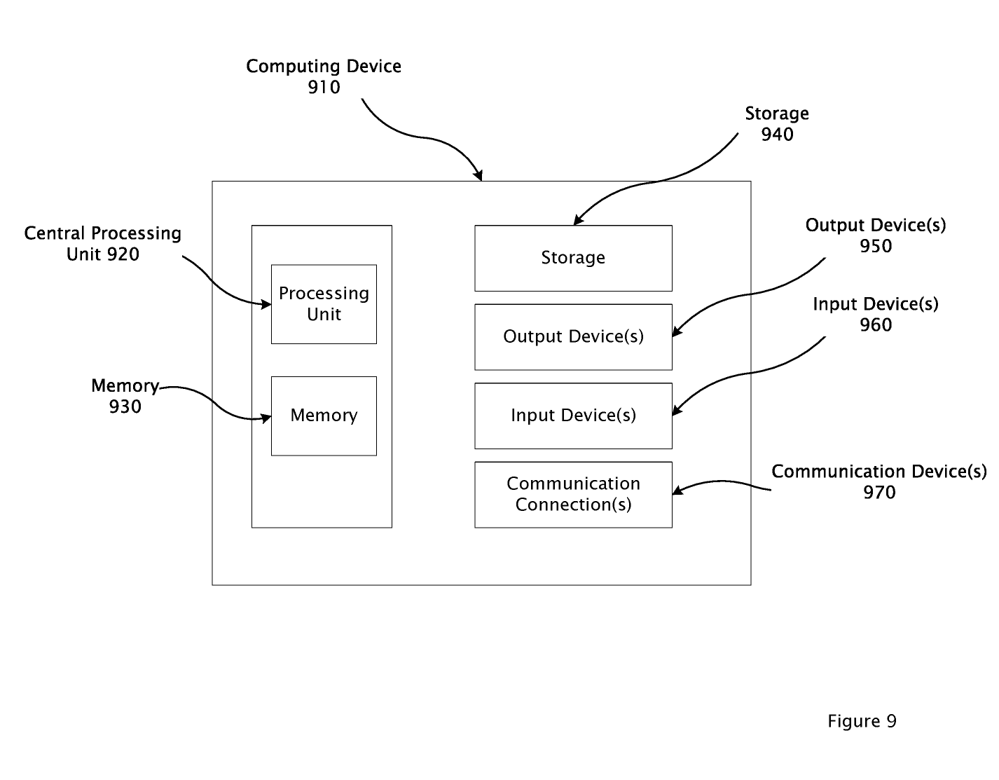

FIG. 9 is a component diagram of a computing device which Networked Camera 200 may include according to one embodiment. This figure is a component diagram of a computing device which may support a cause tracking service process according to one embodiment. Computing Device 910 can be utilized to implement one or more computing devices, computer processes, or software modules described herein, including, for example, but not limited to a mobile device. In one example, Computing Device 910 can be used to process calculations, execute instructions, and receive and transmit digital signals. In another example, Computing Device 910 can be utilized to process calculations, execute instructions, receive and transmit digital signals, receive and transmit search queries and hypertext, and compile computer code suitable for a mobile device. Computing Device 910 can be any general or special purpose computer now known or to become known capable of performing the steps or performing the functions described herein, either in software, hardware, firmware, or a combination thereof.

In its most basic configuration, Computing Device 910 typically includes at least one Central Processing Unit (CPU) 920 and Memory 930. Depending on the exact configuration and type of Computing Device 910, Memory 930 may be volatile (such as RAM), non-volatile (such as ROM, flash memory, etc.) or some combination of the two. Additionally, Computing Device 910 may also have additional features/functionality. For example, Computing Device 910 may include multiple CPU's. The described methods may be executed in any manner by any processing unit in Computing Device 910. For example, the described process may be executed by both multiple CPUs in parallel.

Computing Device 910 may also include additional storage (removable or non-removable) including, but not limited to, magnetic or optical disks or tape. Such additional storage is illustrated by Storage 940. Computer readable storage media includes volatile and nonvolatile, removable and non-removable media implemented in any method or technology for storage of information such as computer-readable instructions, data structures, program modules or other data. Memory 930 and Storage 940 are all examples of computer-readable storage media. Computer readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by Computing Device 910. Any such computer readable storage media may be part of Computing Device 910. But computer readable storage media does not include transient signals.

Computing Device 910 may also contain Communications Device(s) 970 that allow the device to communicate with other devices. Communications Device(s) 970 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared and other wireless media. The term computer-readable media as used herein includes both computer readable storage media and communication media. The described methods may be encoded in any computer-readable media in any form, such as data, computer-executable instructions, and the like.

Computing Device 910 may also have Input Device(s) 960 such as keyboard, mouse, pen, voice input device, touch input device, etc. Output Device(s) 950 such as a display, speakers, printer, etc. may also be included. All these devices are well known in the art and need not be discussed at length.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a digital signal processor (DSP), programmable logic array, or the like.

While the detailed description above has been expressed in terms of specific examples, those skilled in the art will appreciate that many other configurations could be used. Accordingly, it will be appreciated that various equivalent modifications of the above-described embodiments may be made without departing from the spirit and scope of the invention.

Additionally, the illustrated operations in the description show certain events occurring in a certain order. In alternative embodiments, certain operations may be performed in a different order, modified or removed. Moreover, steps may be added to the above-described logic and still conform to the described embodiments. Further, operations described herein may occur sequentially, or certain operations may be processed in parallel. Yet further operations may be performed by a single processing unit or by distributed processing units.

The foregoing description of various embodiments of the invention has been presented for the purposes of illustration and description. It is not intended to be exhaustive or to limit the invention to the precise form disclosed. It is intended that the scope of the invention be limited not by this detailed description, but rather by the claims appended hereto. The above specification, examples, and data provide a complete description of the manufacture and use of the invention. Since many embodiments of the invention can be made without departing from the spirit and scope of the invention, the invention resides in the claims hereinafter appended.

1. A system comprising:
a device; the device operably coupled to a network;
a camera, the camera operably coupled to the network; and
the camera and the device operable to communicate with each other via the network.

2. The system of claim 1 wherein the device is selected from the group consisting of a switch, a smoke detector, a sensor, a photoelectric beam detector, a metal detector, a thermal detector, an alarm panel, a hub and a sound wave detector.

3. The system of claim 1 wherein the camera is operable to receive a command from the device.

4. The system of claim 1 wherein the device is operable to receive a command from the camera.

5. A method comprising:
receiving at a first camera from a second camera a first command, the first command including an instruction for the first camera; and
executing the instruction on the first camera.

6. The method of claim 5, wherein the instruction is to monitor a geographical area.

7. The method of claim 5, wherein the instruction is a conditional instruction for the first camera to monitor a geographical area if a specified condition is satisfied.

8. The method of claim 7, wherein the specified condition comprises identifying a person by facial recognition.

9. The method of claim 8 further comprising:
recognizing the identified person as a threat; and
sending a message to a device.

10. The method of claim 9 wherein the message contains visual proof.

11. The method of claim 8 further comprising:
recognizing the identified person is not a threat; and
sending a second command to a device to grant the person access to a resource.

12. The method of claim 8 further comprising:
recognizing the person requires emergency assistance; and
sending a second message to at least one emergency services agency, the message including a visual verification.
